(19) United States
(12) Patent Application Publication
(10) Pub. No.: US 2010/0313612 A1
(43) Pub. Date: Dec. 16, 2010

(54) Low-cost switch sensor remote dead bolt status indicator

(75) Inventors: Joseph Eichenstein, Lakewood, NJ (US); John V. Mizzi, Poughkeepsie, NY (US)

Correspondence Address: ALFRED M. WALKER, 225 OLD COUNTRY ROAD, MELVILLE, NY, 11747-2712, US

(73) Assignee: John V. Mizzi

(21) Appl. No.: 12/456,218

(22) Filed: Jun. 13, 2009

(51) Int. Cl. E05B 41/00; E05B 65/06; E05B 17/00; G05B 19/00

(52) U.S. Cl. 70/124; 70/432; 70/431; 340/5.6

(57) ABSTRACT

A low-cost switch sensor remote dead bolt status indicator includes a switch sensor which starts a transmitter at a door lock location upon sensing of a dead bolt entering into a locked position. The transmitter is provided with a self shut-off feature operating after a fixed duration of minutes length has elapsed. The indicator also includes a receiver in a hand held unit, such as a key fob capable of receiving signals from the transmitter after the user presses an inquiry key on its surface. The hand held receiver having two indicators for alternately displaying the lock's dead bolt status as being locked or unlocked. In an alternate embodiment, the switch sensor is provided as an integral part bonded to the conventional manufactured metal strike plate dead bolt frame that is typically attached to the door jamb.

### FIELD OF THE INVENTION

The present invention relates to low cost remote reminders whether a dead bolt lock of a building door is locked or unlocked.

### BACKGROUND OF THE INVENTION

People often leave their house and wonder whether they locked the dead bolt of their front door. Typically they would have to get out of their car and return to the house and check to see if the door is bolted. While remote status checking devices using radio communications links are known, a simple low cost device is needed.

US Patent application 2004/0080403 of Eshel relates to a lock status indicator. It comprises a remote indicator in the form of a key fob that has a visual or audio indication of the status of a vehicle lock. A time indicating device may also display the time of the last lock status change. No information on the communication sequence or operation of the indicator is provided by the inventor.

U.S. Pat. No. 6,703,919 of Baset describes a method of confirming remote keyless entry lock status using a key fob with a counter that is incremented when the lock button is pressed and reset to zero when the unlock button is activated.

U.S. Pat. No. 6,166,634 of Dean is a garage door status signaling device using a transmitter attached to a switch at the garage door. This transmitter is activated when the garage door is opened thereby sending a signal to a remote receiver (always on) with an interval timer to activate an alarm.

U.S. Pat. No. 7,196,623 of Wang is a remote reminding system to warn a user of an undesirable condition of an appliance or garage door. This is a long-range radio communications system whereby the remote unit sends signals to poll the base unit continuously. The remote unit has a computer for decrypting the encoded data and making decisions based on received information as to inform the user of certain undesirable conditions of specific appliances.

U.S. Pat. No. 7,498,936 of Maeng for a wireless event status system can be used to ascertain the status of a building door lock remotely. An informer transmitter at the door operates to transmit a status signal whenever the door lock status is changed. A receiver in a remote key fob receives the signal since it is always in the active receive state. A visual indicator in the form of a status light on the key fob is turned on or off by the received signal to indicate if the door is locked or unlocked. This last status is stored in the key fob for interrogation when the key fob is out of range of the informer transmitter.

U.S. Pat. No. 4,490,999 of Castle describes a non-electronic, mechanical door lock indicator with a rotary indicator viewable through a transparent window. The indicator is synchronized with the movement of the door bolt to indicate whether the door is locked or unlocked.

However, the prior art does not reveal a remote dead bolt status indicator which is low cost and uses a switch sensor easily installed by the customer.

### OBJECTS OF THE INVENTION

It is an object of the present invention to provide a low-cost switch sensor remote dead bolt status indicator.

It is also an object of the present invention to provide a switch sensor which starts a transmitter at a door lock location upon sensing the instant that a dead bolt is locked.

It is also an object of the present invention to provide a low cost remote door lock indicator with a self shut-off feature operating after a fixed duration of time length has elapsed.

It is yet another object of the present invention to provide a switch sensor of the transmitter, whereby the switch sensor is provided at a location in the vicinity of the strike plate having an opening through which the dead bolt locks the door, so that the transmitter can communicate with the user's remote, hand held key fob indicator.

It is also an object of the present invention to improve over the disadvantages of the prior art.

### SUMMARY OF THE INVENTION

In keeping with these objects and others which may become apparent, this invention is a low-cost system using a transmitter unit comprising a transmitter and a switch sensor to detect the presence of a dead bolt in a locked position, whereby the door to secured is assuredly locked/secured. The switch sensor is dual purpose. It is used to start the transmitter operation as well as to sense the bolt position in a very direct manner. The transmitter is low voltage or battery operated, such as, for example, using ordinary alkaline batteries (such as 2 or 3 AA cells). This type of power for powering the transmitter unit avoids the first cost of an AC line-powered power supply or charging stand; an ugly extension cord is also avoided in this manner. Please note, however, that an alternative embodiment includes AC/DC converter connected to power the switch sensor, transmitter and any logical circuitry for application where changing a battery would be inconvenient. A very small hand-held indicator, such as a key fob powered by a button cell, contains a receiver to communicate with the transmitter at the door.

A major feature of this invention is the ease of installation of the transmitter unit at the door with the switch sensor by a customer with average skills and minimal tools. In fact, the only tool necessary is a drill capable of drilling a single hole adjacent the dead bolt. Beyond low first cost, low cost operation in terms of long battery life is also a feature of this invention.

Since only short range communications between the transmitter and receiver in the hand-held indicator is required for this invention, advantage is taken of radio frequency bands reserved for such low power communications. In the United States, the FCC permits “unlicensed operation” (under CFR 47 part 15 regulations) of such devices in the 900 MHz, the 2.4 GHz, and the 5.8 GHz bands. Other jurisdictions have reserved bands for similar operation. Any of these bands can be used.

The low-cost features inherent to the design of this invention first relate to the communications concept and operation. At the door that is secured, the transmitter unit comprises only a simple transmitter (not a transceiver) and sensor. At the key fob, only a simple receiver (not a transceiver) is required for receiving signals transmitted from the transmitter unit. This is different than complex prior art transceivers which need transmissions in both directions or have a receiver that is always “on”, and which may be capable of performing tasks other than visual indicator status, such as locking an unlocked door from a remote position. Those features are not within the scope of the present invention.

The operation which supports the use of such a spartan system is as follows:

The switch sensor is located at the door being monitored and configured to detect an open position and a closed position of a deadbolt by which the door is secured. Upon detection of the dead bolt in the locked position, the sensor immediately starts the transmitter sending a signal in the frequency range at which the receiver in the key fob is tuned for a predetermined short time period (preferably set to be 5 minutes or less); at the end of the period, the transmitter subsystem shuts itself off regardless of the switch sensor still being activated. This self-shutoff is similar to the automatic shutoff of a digital camera after a period of non use.

If a key fob inquiry button is pressed during this transmission period and the key fob is within the range of the transmitter, the receiver within the key fob receive state is activated, the transmitted signal from the transmitter located at the door is received and a signal is generated that activates a visual or other sensory perceptible indicator, such as a green LED indicator, indicating that the dead bolt is in its locked position. Other visual or vibratory indicators may be used.

However, if the key fob inquiry button is activated shortly after the user has exited the door with the transmitter unit, and the transmitter is not transmitting the signal representative of detection of the deadbolt in its locked position but still within an operational range, the logical circuitry in the key fob decides that the deadbolt is not in its locked position. A signal is then generated to activate a visual or other sensory perceptible indicator, such as a (preferably) blinking red LED, which will glow indicating that the person has forgotten to operate the dead bolt. Any operation of the key fob out of range or after the normal transmission period will give the same blinking red LED indication even if the dead bolt is in the locked position.

Other features that are related to low cost include the switch sensor assembly. This preferably includes a few easily assembled components, such as molded plastic parts affording easy custom adjustment for most installations with a low cost switch, such as, for example, a momentary single pole, single throw SPST switch which can be a membrane switch of the type used on a telephone or calculator. Other types of switch sensors, such as magnetic, optical, ultrasonic or motion sensors and the like, can be used, as are known to those skilled in the art.

To greatly extend the life of the transmitter subassembly battery, the signal transmission is preferably pulse modulated with full power pulses of a reduced nature, such as, for example, only a 5% duty cycle or less, for example, pulses of radio frequency of 5 ms duration every 100 ms period. In this manner, full range is not sacrificed since the pulses are full power, but the battery life is extended over ten-fold compared to continuous full power transmission over the five minute transmission periods. The service life of the key fob receiver battery is very long since the receiver and indicator LED's are only operated while the inquiry button is pressed. Besides, a receiver function is a low power device compared to the transmitter function of a normal remote keyless entry automotive fob. The key fob unit is configured for easy replacement of the battery cell therein.

In an alternate embodiment, the switch sensor is provided as an integral part bonded to the conventional manufactured metal strike plate dead bolt frame that is typically attached to the door jamb. The switch sensor may be attached to the metal strike plate by two fingers extending rearward from the strike plate, or by any other mounting means which mounts the sensor to the strike plate in the vicinity of where the dead bolt moves to during the locking operation. The important feature is that the dead bolt, upon locking, is introduced through the cowling of the access hole of the strike plate in a locked position, where it activates the switch sensor concealed within an access hole for the deadbolt. The switch sensor generates a signal to activate the transmitter assembly communicating with the user's key fob, i.e., the receiver thereat. The switch sensor is preferably therefore concealed within the access hole for the dead bolt. It is a very low profile, dome operated switch, requiring only a small hole through to the interior for a small gage two-conductor cable to the transmitter assembly. This alternate embodiment simplifies the installation of the security system. Costs are minimal in view of the fact that the door jamb strike plate may be manufactured with the switch sensor by a dead bolt lock manufacturer.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a front elevation detail of the interior side of the door configured with a locking system of the invention, and including a wall adjacent the door upon which a transmitter unit with switch sensor and transmitter is shown mounted relative to a dead bolt lock.

FIG. 2 is a perspective view of the receiver key fob of this invention.

FIG. 3 is an enlarged front detail of the interior side of the door configured with a locking system of the invention that highlights a dead bolt bridging the gap between the door edge and door jamb relative to the position of the switch sensor assembly.

FIG. 4 is a side crossectional view of the dead bolt and switch sensor assembly.

FIG. 5 is a side exploded view of the various parts of the switch sensor assembly.

FIG. 6 is a block diagram of the transmitter subassembly and the receiver key fob.

FIG. 7 is a perspective view of a dead bolt strike plate with integral switch sensor constructed in accordance with the invention.

FIG. 8 is a side view of the strike plate of FIG. 7.

FIG. 9 is a back view of the strike plate of FIG. 7.

### DETAILED DESCRIPTION OF THE INVENTION

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention, as defined by the appended claims. The descriptions below are designed to make such embodiments obvious to a person of ordinary skill in the art.

A low-cost switch sensor remote dead bolt status indicator includes a switch sensor which starts a transmitter at a door lock location upon sensing of a dead bolt being in a locked position. The transmitter is provided with a self shut-off feature operating after a fixed duration of minutes length has elapsed. The indicator also includes a receiver in a hand held unit, such as a key fob capable of receiving signals from the transmitter after the user presses an inquiry key on its surface. The hand held receiver has two indicators for alternately displaying the lock's dead bolt status as being locked or unlocked. In an alternate embodiment, the switch sensor is provided as an integral part bonded to the conventional manufactured metal strike plate dead bolt frame that is typically attached to the door jamb.

Turning now to FIG. 1, a physical location of transmitter subassembly 11 with switch sensor assembly 10 relative to a door 1 with dead bolt lock 3 is shown in FIG. 1. Door knob 2 is shown in its normal location below lock 3. Doorjamb molding 7 on wall 6 is the location for installation of switch sensor assembly across from lock 3 and in the path of the dead bolt. Snap off panel 12 on transmitter subassembly 11 permits access for changing batteries.

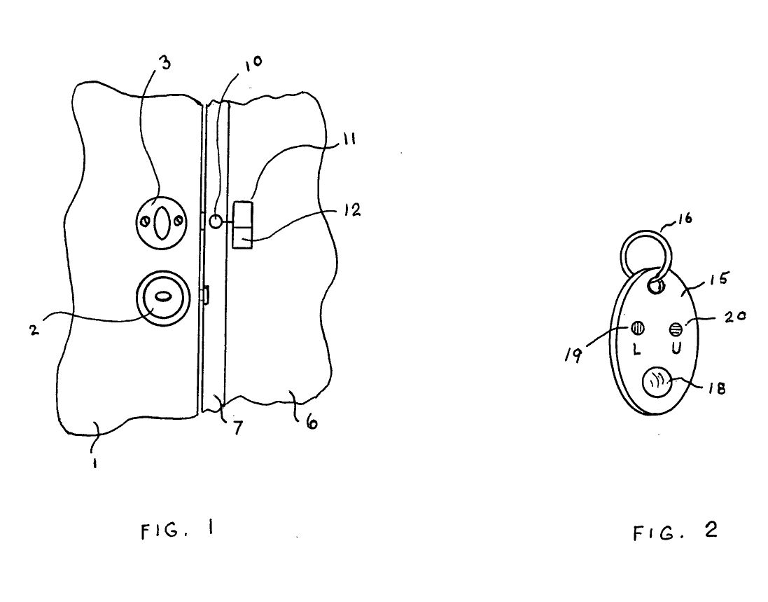

FIG. 2 shows a hand held indicator, such as key fob 15, with inquiry input, such as switch button 18, first sensory perceptible indicator, such as green indicator LED 19 and second sensory perceptible indicator, such as red flashing LED 20. Optional key ring 16 permits attachment to keys or other items.

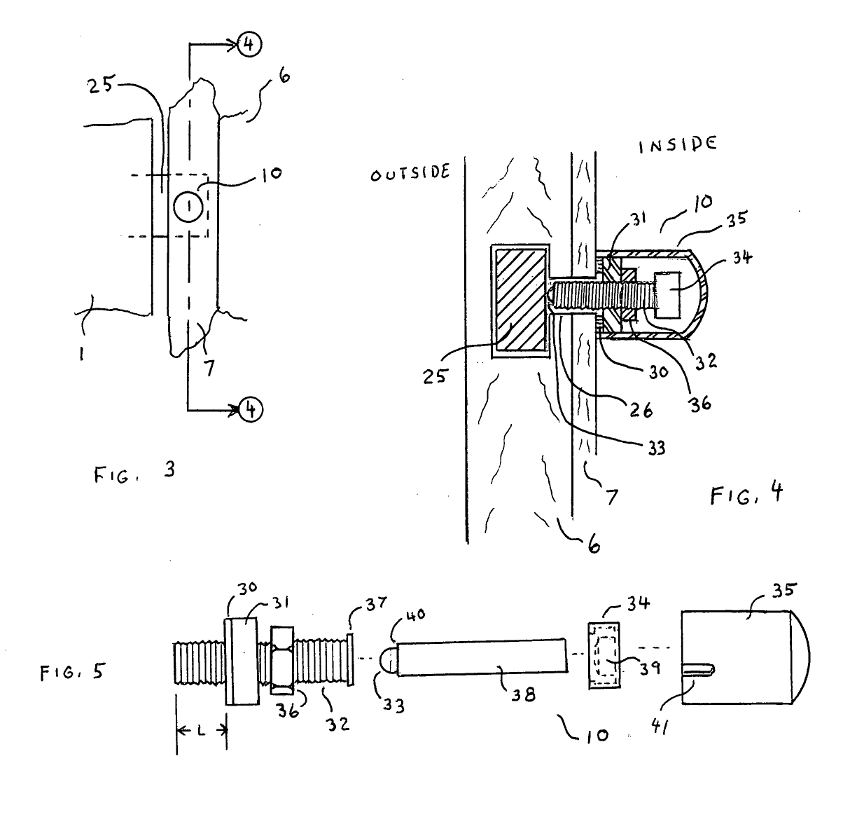

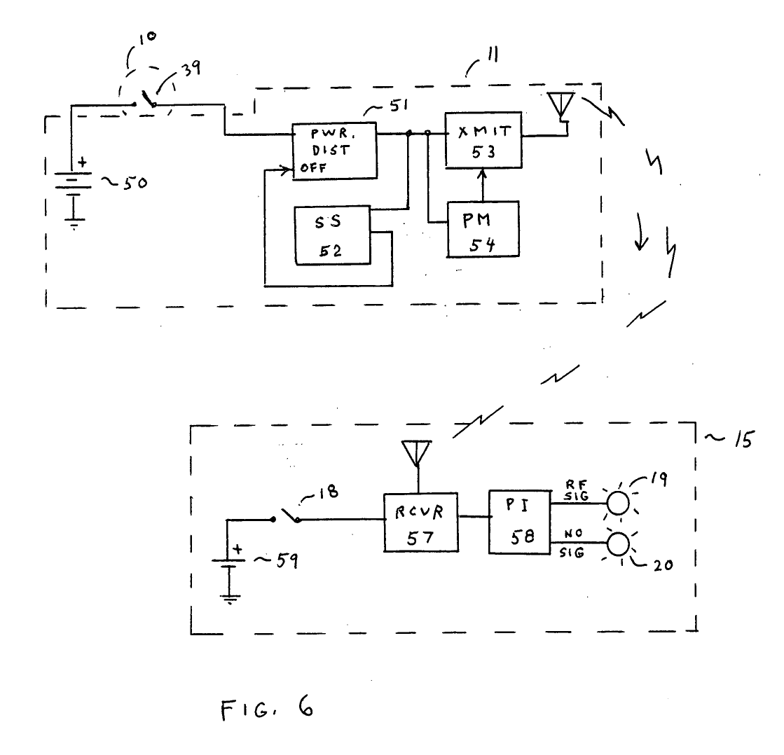

FIGS. 3-5 show details of the switch sensor assembly 10 and its installation on a door jamb. FIG. 3 is a detail showing dead bolt 25 in its locked position extending (in dashed lines) beyond the location of switch assembly 10 on molding 7 which is typically at the edge of the doorjamb. If there is no molding, the installation may be slightly simplified. In the crossection of FIG. 4, hole 26 (preferably approximately ¼″ diameter) can be seen going through the molding 7 and beyond into the cavity that receives dead bolt 25. This is the only hole necessary for the installation. Both transmitter subassembly 11 and switch sensor assembly 10 are attached using a fastener means, such as a pressure sensitive foam adhesive layer which is exposed after the customer peels away a release liner. Other fasteners such as hook and loop VELCRO® can be alternately used. Since the thickness of the door jamb and molding 7 (if encountered) is a variable, switch assembly 10 is adjustable to accommodate these variables. In the exploded view of FIG. 5, hollow guide 32, preferably a plastic molding with external threads, is engaged with threaded thick base 31, another molded part, and is also threaded into lock nut 36. Guide 32 fits into hole 26 (see FIG. 4) and is adjusted by screwing base 31 so that a contact portion, such as hemispherical tip 33 of an actuator, such as actuator rod 38 is pushed a short distance by impingement with the side surface of dead bolt 25, thereby pushing actuator rod 38 away from the distal end within hollow guide 32 thereby actuating switch 39 bonded within snap housing 34. The correct distance for reliable operation, “L”, is then locked by a further fastener, such as by screwing a fastener, such as a lock nut 36, down into contact with base 31. Note that actuator rod 38 is prevented from exiting guide 32 at its distal end because the reduced diameter exit hole at that end (not shown) impinges on step 40. Optional flange 37 on guide 32 permits snap housing 34 to snap over and engage guide 32 while still permitting rotation of cap 34 so as to rotate it to properly guide the two conductor cable which will be attached inside transmitter housing 11. Note that a press fit closure, such as foam adhesive layer 30, is used to attach base 31 (and thereby assembly 10) to the surface of molding 7. To complete the installation of switch assembly 10, optional dust cap 35 is rotated so that the cable is in registration with “mousehole” notch 41 and then fitted over base 31 with a friction fit.

FIG. 6 shows block diagrams of transmitter subassembly 11 as well as key fob 15. Regarding transmitter subassembly 11, battery 50 is routed through switch sensor 39 into a power distribution block 51 which typically incorporates a MOSFET element. Thus power is preferably made available to transmitter 53, single shot timer 52, and pulse modulator 54. When timer 52 times out its interval (preferably 5 minutes or less), it signals power distribution block 51 to disable power to all of the elements. Transmitter 53 is simple enough to be assembled of discrete components especially since there are no stringent size constraints, but a single integrated circuit transmitter such as the nRF2404 from Nordic Semiconductor (Tiller, Norway) can be used instead. Both blocks 52 and 54 can be can be built using CMOS integrated circuit timers such as the infamous “556” series, but both blocks can be software implemented using a single appliance grade 8-bit microprocessor instead.

Key fob 15 uses a low voltage power source, such as, for example, button cell 59 for power. User input is preferably achieved by momentary push button switch 18, which serves the “inquiry” function powering receiver 57 and pulse integrator 58 to energize either green LED 19 if an RF signal had been detected or alternatively flashing red LED 20 if no signal had been detected. Receiver 57 would benefit from being a single chip integrated circuit due to the reduced space within key fob 15. Other display options besides LED's are available including liquid crystal geometric or alpha types.

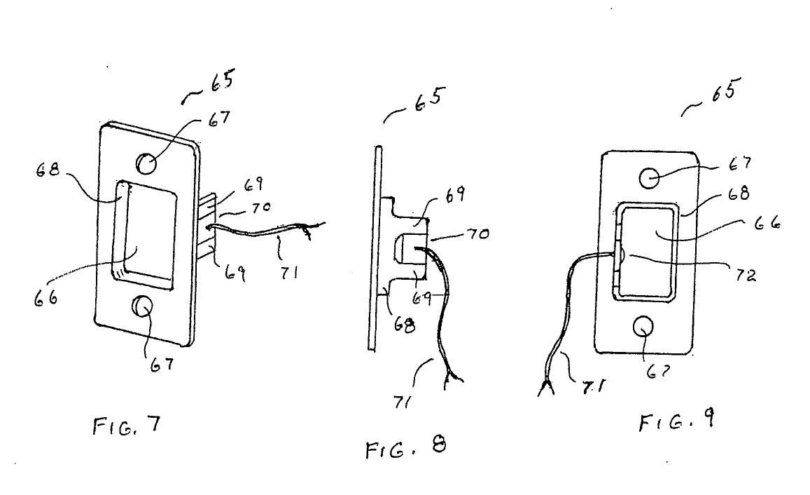

In the alternate embodiment shown in FIGS. 7-9, a metal strike plate 65 framing the dead bolt opening normally attached to the doorjamb has been modified with extensions 69 to accept a low profile switch sensor 70 which is permanently bonded to it. In FIG. 7, metal strike plate 65 with mounting holes 67 and dead bolt opening 66 is shown with rounded edge cowling 68 which smoothly guides bolt 25 into hole 66. FIG. 8 clearly shows extension fingers 69 which emanate from cowling 68 to form a bonding anchor for switch sensor 70. Switch 70 is attached to transmitter subassembly 11 via dual conductor 71 which is passed through a small diameter hole (approximately 3/32″) to the interior of the doorjamb. No adjustment of the switch sensor is necessary as its actuation dome 72 (see FIG. 9) is strategically located to be depressed by bolt 25 when it is deployed through plate 65 to lock the door.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

I claim:

1. A low-cost wireless electronic system for notifying a user of a locked/unlocked position of a dead bolt used for securing a door to a door frame, comprising:
a switch sensor for mounting proximate a recess in the door frame, the recess configured to receive the dead bolt, wherein the switch sensor senses the dead bolt locked position and generates a “locked” indicator signal when the dead bolt is initially placed in a locked position;
a transmitter unit including a transmitter that is electrically connected to the switch sensor for receiving the locked signal, and transmitting a status signal identifying the dead bolt is in its locked position in response thereto, said transmitter unit being provided with a self shut-off feature operating after a fixed duration of minutes length has elapsed; and
a key fob including an inquiry key, a status indicator for indicating a locked/unlocked status of the dead bolt, and a receiver in said key fob capable of receiving the transmitted locked status signal, wherein the receiver is activated to receive the locked status signal from said transmitter only after an inquiry key on its surface is pressed; and,
said receiver having two sensory perceptible indicators for displaying said dead bolt status as locked or unlocked.

2. The low cost wireless electronic system as set forth in claim 1, wherein said transmitter is pulse width modulated to vary a duty cycle of the transmitted status signal.

3. The low cost wireless electronic system as set forth in claim 1 wherein said status indicator comprises at least one LED.

4. The low cost wireless electronic system as set forth in claim 1 wherein said switch sensor comprises an integral part that further includes a metal strike plate dead bolt frame, wherein the switch sensor is bonded to said dead bolt frame.

5. The low cost wireless electronic system as set forth in claim 4, wherein said switch sensor is concealably disposed within an access hole through which said dead bolt is inserted in a locking position.

6. The low cost wireless electronic system as set forth in claim 1 wherein said switch sensor is a low profile, dome operated switch.

7. The low cost wireless electronic system as set forth in claim 6 wherein a two-conductor cable connects said switch sensor to said transmitter.

8. The low cost wireless electronic system as set forth in claim 1, further comprising a DC power source connected to the switch sensor and transmitter.

9. The low cost wireless electronic system as set forth in claim 1, further comprising logical circuitry connected to both the transmitter and the switch sensor.

10. The low cost wireless electronic system as set forth in claim 1, wherein the key fob further comprises logical circuitry and a battery, wherein the battery powers the logical circuitry, the status indicator, the inquiry key and the receiver.

11. The low cost wireless electronic system as set forth in claim 9, wherein the logical circuitry controls the transmitter to transmit the “locked” status signal for a fixed time period.

12. The low cost wireless electronic system as set forth in claim 11, wherein the logical circuitry responds to the “locked” signal generated by the switch sensor to control the transmitter to transmit for a fixed length of time.

13. The low cost wireless electronic system as set forth in claim 12, wherein the logical circuitry controls the transmitter to transmit the locked status signal.

14. The low cost wireless electronic system as set forth in claim 10, wherein inquiry key generates an inquiry signal upon depression by a user, and the logical circuitry within the key fob activates the receiver only when the inquiry signal is present.

15. The low cost wireless electronic system as set forth in claim 14, wherein the logical circuitry within the key fob controls the receiver to actively receive periodically, for some portion of a receiving period that is equivalent to the fixed period of time for which the transmitter transmits in response to the switch sensor sensing a change in position of the dead bolt to the locked state.

16. A low-cost dead bolt system for notifying a user when a dead bolt mounted upon a door to be secured is extended in a locking position within a door frame, comprising:
a dead bolt configured for mounting to the door;
a strike plate dead bolt frame configured to be fixedly attached to a doorjamb opposed to the dead bolt when the dead bolt is mounted to the door, the strike plate including a cowling defining an access hole in the strike plate to allow the dead bolt to pass therethrough into a recess in the doorjamb, when the dead bolt is moved in a locked position;
an electronic switch sensor that is fixedly attached to the strike plate for mounting proximate a recess in the door frame, the recess configured to receive the dead bolt, wherein the switch sensor senses the dead bolt upon moving into a locked position and generates a “locked” indicator signal;
a transmitter unit including a transmitter that is electrically connected to the switch sensor for receiving the locked indicator signal, and transmitting a locked status signal based thereon; and
a key fob including an inquiry key, a status indictor for indicating a locked/unlocked status of the dead bolt, and a receiver for receiving the transmitted locked status signal, wherein the receiver is activated to receive the status signal only upon depression of the inquiry key.

17. The low cost dead bolt system as set forth in claim 16, wherein the sensor switch is attached to the strike plate by two fingers extending rearward from the strike plate.

18. The low cost dead bolt system as set forth in claim 16, wherein the sensor switch is a very low profile, dome operated switch.

19. The low cost dead bolt system as set forth in claim 16, wherein the locked indicator signal is generated only upon a movement by the deadbolt into a locked position through the cowling, and the transmitter transmits the locked status signal only for fixed time period upon receipt of the locked indicator signal from the senor switch.

20. The low cost dead bolt system as set forth in claim 19, wherein the transmitter transmits for 300 seconds.

21. The low cost dead bolt system as set forth in claim 20, wherein the key fob receives the locked status signal only when the inquiry key is pressed.
